(19) United States
(12) Patent Application Publication
(10) Pub. No.: US 2024/0118912 A1
(43) Pub. Date: Apr. 11, 2024

(54) SAAS BASED SOLUTION- ORCHESTRATION PLATFORM FOR ORCHESTRATING VIRTUAL NETWORK SOLUTIONS ON PUBLIC/PRIVATE CLOUD INFRASTRUCTURE FOR LEARNING/DEVELOPMENT/EVALUATION/DEMOS/VALIDATION/DEPLOYMENT

(71) Applicants: SRINIVAS VEGESNA, Sunnyvale, CA (US); JAYAPRAKASH KUMAR, Bangalore (IN); PRAMOD VENKATESH, Bangalore (IN); NARESH KUMAR THUKKANI, Bangalore (IN)

(72) Inventors: SRINIVAS VEGESNA, Sunnyvale, CA (US); JAYAPRAKASH KUMAR, Bangalore (IN); PRAMOD VENKATESH, Bangalore (IN); NARESH KUMAR THUKKANI, Bangalore (IN)

(21) Appl. No.: 18/137,977

(22) Filed: Apr. 21, 2023

Related U.S. Application Data
(63) Continuation-in-part of application No. 16/356,426, filed on Mar. 18, 2019.
Application No. 16/356,426 is a continuation-in-part of application No. 15/996,522, filed on Jun. 4, 2018, now abandoned.
(60) Provisional application No. 62/572,661, filed on Oct. 16, 2017.

(51) Int. Cl. G06F 9/455

(52) U.S. Cl. CPC G06F 9/45558; G06F 2009/45575; G06F 2009/45583

(57) ABSTRACT

In one aspect, a computerized method useful for saving a virtual machine comprising: creating a virtual machine on a hypervisor; issuing a request to a central orchestrator to save the virtual machine, wherein the central orchestrator is accessed via a monitor interface, and wherein the central orchestrator communicates with a plurality of virtual machines that includes the virtual machine; with the central orchestrator, connecting to a hypervisor manager located on the hypervisor where the virtual machine is located on the hypervisor and passes a set of information comprising a VM storage image location.

### CLAIM OF PRIORITY AND INCORPORATION BY REFERENCE

This patent application claims priority from and is a continuation in part of U.S. application Ser. No. 16/356,426, titled METHODS AND SYSTEMS FOR A VIRTUAL TOP-OF-RACK IMPLEMENTATION and filed Mar. 18, 2019. This application is hereby incorporated by reference in its entirety for all purposes.

U.S. application Ser. No. 16/356,426 claims priority from and is a continuation in part of U.S. application Ser. No. 15/996,522, titled SAAS BASED SOLUTION-ORCHESTRATION PLATFORM FOR ORCHESTRATING VIRTUAL NETWORK SOLUTIONS ON PUBLIC/PRIVATE CLOUD INFRASTRUCTURE FOR LEARNING/DEVELOPMENT/EVALUATION/DEMOS/VALIDATION/DEPLOYMENT and filed Jun. 4, 2018. This application is hereby incorporated by reference in its entirety for all purposes.

U.S. application Ser. No. 15/996,522 claims priority from U.S. Provisional Application No. 62/572,661, title ORCHESTRATING SDN/NFV/CLOUD SOLUTIONS ON PUBLIC/PRIVATE CLOUD INFRASTRUCTURE FOR DEVELOPMENT/VALIDATION/DEPLOYMENT and filed 16 Oct. 2017. This application is hereby incorporated by reference in its entirety for all purposes.

### FIELD OF THE INVENTION

The invention is in the field of computer networks and more specifically to a method, system and apparatus of an orchestrating SDN/NFV/cloud solutions on public/private cloud infrastructure for development/validation/deployment.

### DESCRIPTION OF THE RELATED ART

Recent years have seen the disaggregation of network infrastructure and virtual network functions replacing physical network functions. Furthermore, lines between public and private cloud infrastructure are being blurred. Accordingly, methods to provide quick and easy ways for network operators to adopt solutions based on multi-vendor products (some of them cloud based) are desired to enable transformation of said networks.

### SUMMARY

In one aspect, a computerized method useful for saving a virtual machine (VM) comprising: creating a virtual machine on a hypervisor; issuing a request to a central orchestrator to save the virtual machine, wherein the central orchestrator is accessed via a monitor interface, and wherein the central orchestrator communicates with a plurality of virtual machines that includes the virtual machine; with the central orchestrator, connecting to a hypervisor manager located on the hypervisor where the virtual machine is located on the hypervisor and passes a set of information comprising a VM storage image location, and a VM memory image location, and wherein a VM memory image comprises a memory dump or Random Access Memory (RAM) of the VM; with the hypervisor, performing a suspend operation on the virtual machine, wherein the suspend operation dumps a memory of the virtual machine into a disk of the hypervisor; shutting down the virtual machine; with the hypervisor manager, uploading both the virtual machine disk and the memory data into a virtual machine storage repository, and the memory data into a memory storage repository, with the hypervisor manager, removing an entry of the virtual machine from the hypervisor; with the hypervisor manager, sending a location information and the virtual machine's information to the central orchestrator for storage of the virtual machine's information; resuming the virtual machine in a saved state with the central orchestrator, wherein the set of steps comprises: with the central orchestrator: determining that there are sufficient resources to provision the virtual machine in a specified computing system, and connecting the central orchestrator to the hypervisor manager and passing the information containing the virtual machine's storage image location, the memory image location, and the virtual machine metadata information; with the hypervisor manager: downloading the virtual machine's disk from the virtual machine's storage image location, and the virtual machine memory image from the memory image location, connecting to the hypervisor and creating a virtual machine using the virtual machine's metadata, and placing the virtual machine's memory image and the virtual machine's storage image in a specified location; and with the hypervisor: determining that the virtual machine's disk image and the virtual machine's memory image are present, and performing the resume functionality in the hypervisor.

### BRIEF DESCRIPTION OF THE DRAWINGS

The present application can be best understood by reference to the following description taken in conjunction with the accompanying figures, in which like parts may be referred to by like numerals.

FIG. 1 illustrates an example SaaS-based Platform, according to some embodiments.

FIG. 2 provides an example distributed application which involves a software load balancer, front end servers, backend servers, queue, DB deployed on five (5) Nodes, according to some embodiments.

FIG. 3 illustrates an example sequence of installation and configuration for the system of FIG. 2, according to some embodiments.

FIG. 4 illustrates an example system of large-scale replicated deployment, according to some embodiments.

FIG. 5 illustrates an example Network Multi-Master Deployer (NMMD) system, according to some embodiments.

FIG. 6 provides an example component distribution, according to some embodiments.

FIG. 7 illustrates an example system for saving virtual machines in a sandbox environment, according to some embodiments.

FIG. 8 illustrates an example process for saving a virtual machine, according to some embodiments.

FIG. 9 illustrates an example process for resuming a VM, according to some embodiments.

FIG. 10 depicts an exemplary computing system that can be configured to perform any one of the processes provided herein.

The Figures described above are a representative set, and are not an exhaustive with respect to embodying the invention.

### DESCRIPTION

Disclosed are a system, method, and article of manufacture of orchestrating SDN/NFV/cloud solutions on public/private cloud infrastructure for development/validation/deployment. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Hypervisor is computer software, firmware or hardware that creates and runs virtual machines.

Input-output memory management unit (IOMMU) is a memory management unit (MMU) that connects a direct-memory-access-capable (DMA-capable) I/O bus to the main memory.

Internet Protocol (IP) address can be a computer's address under the Internet Protocol.

Network functions virtualization (NFV) is a network architecture concept that uses the technologies of IT virtualization to virtualize entire classes of network node functions into building blocks that may connect, or chain together, to create communication services.

Network Multi-Master Deployer (NMMD) includes the following components: Node Discovery Engine; Deployment Model Repository; Cluster Manager; Service Discovery Engine; and/or Central Manager.

REpresentational State Transfer (REST) is a software architectural style that describes the architecture of the Web. It can include following constraints: client-server communication; stateless communication; caching; uniform interface; layered system; code on demand; etc. A system that complies with some or all of these constraints is loosely referred to as RESTful. The uniform interface itself creates four interface constraints: identification of resources; manipulation of resources through representations; self-descriptive messages; Hypermedia As The Engine Of Application State (HATEOAS); etc. Although REST is the architecture of the Web, it has not been widely employed throughout the software industry as the architecture for Web services APIs.

Sandbox can be an online environment in which code or content changes can be tested without affecting the original system.

Software-defined networking (SDN) technology is an approach to cloud computing that facilitates network management and enables programmatically efficient network configuration in order to improve network performance and monitoring.

Single root input/output virtualization (SR-IOV) can be a specification that allows the isolation of the PCI Express resources for manageability and performance reasons. A single physical PCI Express can be shared on a virtual environment using the SR-IOV specification. The SR-IOV offers different virtual functions (e.g. a SR-IOV Virtual Function) to different virtual components (e.g. network adapter) on a physical server machine. The SR-IOV allows different virtual machines (VMs) in a virtual environment to share a single PCI Express hardware interface.

Software as a service (SaaS) is a software licensing and delivery model in which software is licensed on a subscription basis and is centrally hosted.

Top-of-rack (TOR) switch can be a network architecture design in which computing equipment like servers, appliances and other switches located within the same or adjacent rack are connected to an in-rack network switch.

Virtual machine (VM) can be an emulation of a computer system. Virtual machines are based on computer architectures and provide functionality of a physical computer. Their implementations may involve specialized hardware, software, or a combination.

Virtual LAN (VLAN) is any broadcast domain that is partitioned and isolated in a computer network at the data link layer.

Virtual Extensible LAN (VXLAN) is a network virtualization technology that attempts to address the scalability problems associated with large cloud computing deployments. It uses a VLAN-like encapsulation technique to encapsulate MAC-based OSI layer 2 Ethernet frames within layer 4 UDP packets.

YANG (Yet Another Next Generation) is a data modeling language for the definition of data sent over the NETCONF network configuration protocol.

Example Systems and Methods

A SaaS-based Platform is provided that enables operators to learn, develop, test, evaluate and/or deploy multi-vendor network and information technology (IT) solutions. The SaaS-based Platform provides a framework to model the solutions on public and/or private cloud infrastructures. The SaaS-based Platform provides a practical means to test the assumptions around deployment. The SaaS-based Platform utilizes advanced software defined networking and virtualization concepts as an integral part of the platform.

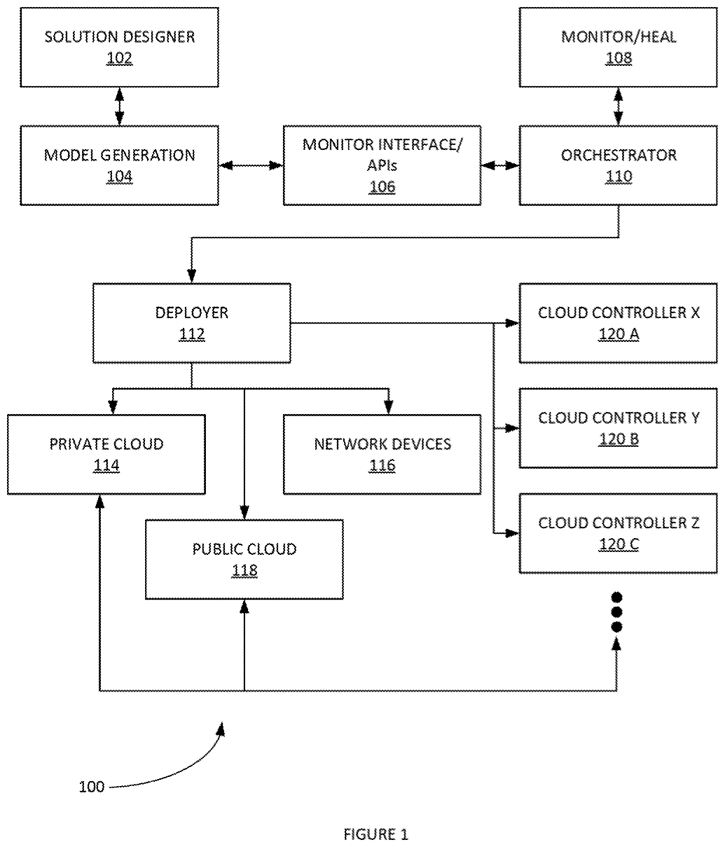

FIG. 1 illustrates an example SaaS-based Platform 100, according to some embodiments. SaaS-based Platform 100 include various components as shown. SaaS-based Platform 100 can include Learning, Lab Services and Custom Solution Designs. These can be hosted in a cloud-orchestration platform (e.g. see infra). SaaS-based Platform 100 is a model driven solution-orchestration platform for SDN/NFV/Cloud solution design, development, testing, validation and deployment. SaaS-based Platform 100 provides a complete DevOPS enabled framework to do end to end orchestration of complex multi-vendor network solutions on public or private cloud infrastructure. SaaS-based Platform 100 includes an orchestrator engine and deployer that provides a means to do one touch deployment of virtual test-beds on physical/virtual networks and public/private cloud infrastructures. Deployments can be done on virtualized, bare metal or nested virtualized environments. Deployer can communicate with multiple cloud controllers which eventually communicate to public or private clouds (e.g. in parallel with network devices). SaaS-based Platform 100 includes an infrastructure for monitoring and self-healing of deployed services. SaaS-based Platform 100 includes a design and modelling framework that enables users to create and deploy the solutions. SaaS-based Platform 100 includes various billing/administrative functions. SaaS-based Platform 100 includes a Web/API interface as solution designer 102.

SaaS-based Platform 100 can suspend/resume features to save and recover deployed solutions. Accordingly, SaaS-based Platform 100 also provides a mechanism to test hardware acceleration capabilities on cloud infrastructure. SaaS-based Platform 100 provides a one touch deployment of solutions. SaaS-based Platform 100 provides a framework to extend the cloud-based test-beds into customer lab environments. SaaS-based Platform 100 can enable various secure deployments. In this way, SaaS-based Platform can enable various software defined networking, network function virtualization and cloud-based network solutions. Many of the functionalities can be implemented by orchestrator 110. Orchestrator 110 can be accessed via monitor interface/APIs 106. Orchestrator 110 can be a central orchestrator.

Model generation 104 enables, for every topology in terms of a custom design of a solution, the generation of topology models (e.g. based on YANG). Monitor/heal 108 can implement active monitoring of the components of SaaS-based Platform 100. Monitor/heal 108 can provide a monitoring and healing capacity for a virtual network solution. Deployer 112 deploy the solution provided by orchestrator 110 to a public cloud 118, private cloud 114, etc. Deployer 112 can monitory network devices 116. Cloud-controllers 120 A-C can be any cloud controller used to manage public cloud 118, private cloud 114, etc.

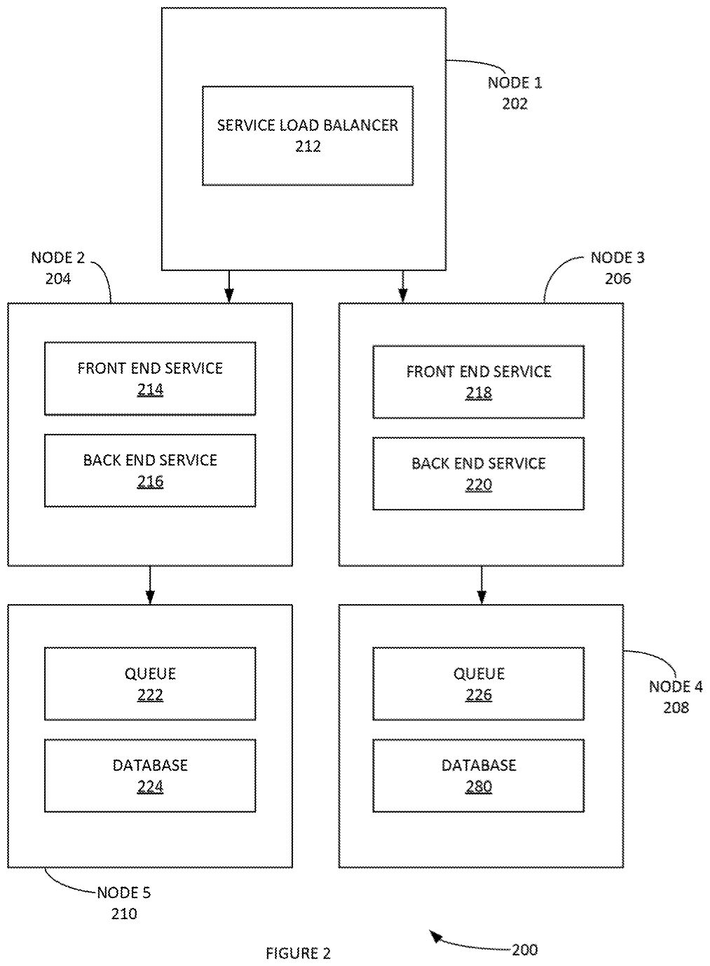

FIG. 2 provides an example distributed application which involves a software load balancer, front end servers, backend servers, queue, DB deployed on five (5) Nodes 202, 204, 206, 208 and 210, according to some embodiments. Node 1 202 can include a service load balancer 212. Nodes 2 and 3 204, 206 can include front end services 214, 218 and back-end services 216, 220 respectively. Nodes 4 and 5 208, 210 can include queues 222, 226 and databases (DBs) 224, 228 respectively.

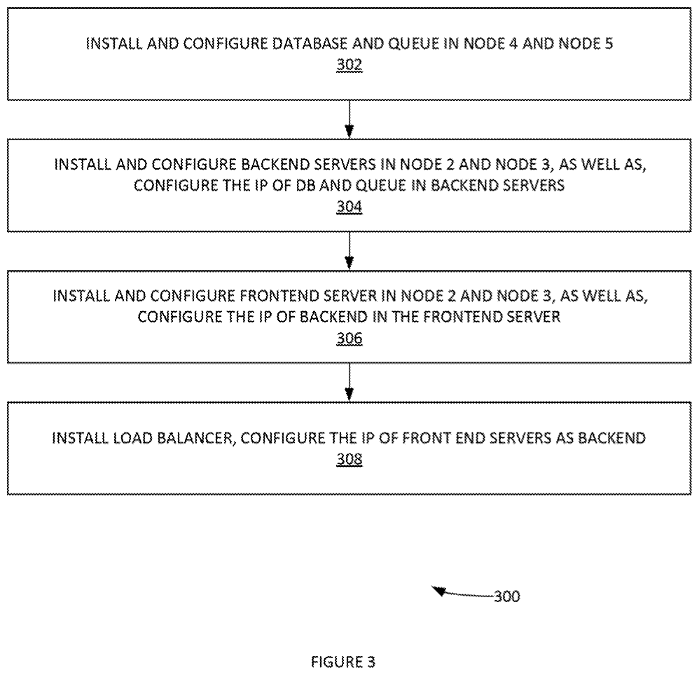

FIG. 3 illustrates an example sequence of installation and configuration for the system of FIG. 2, according to some embodiments. In step 302, process 300 can install and configure database and queue in Node 4 208 and Node 5 210. In step 304, process 300 can install and configure backend servers in Node 2 204 and Node 3 206, as well as, configure the IP of DB and queue in backend servers. In step 306, process 300 can install and configure frontend server in Node 2 204 and Node 3 206, as well as, configure the IP of the backend in the frontend server. In step 308, process 300 can install service load balancer 212, configure the IP of front end servers as a backend server (e.g. 216 and 220).

If process 300 is implemented using a master and slave mode, the following steps can be implemented. A Master can send a message to Agent in Node 4 208 and Node 5 210 to deploy DB 228 and Queue 226. The Agent deploys and sends information regarding the state to Master. The Master then instructs the Agent in Node 2 204 and Node 3 206 to deploy a backend service 220. The Agent deploys and sends information of the same. The Master instructs the Agent in Node 1 202 to deploy service load balancer 212. The Agent deploys and informs the state to Master. If there is an issue during the previous steps, the Agent communicates to the Master and again the Master messages back.

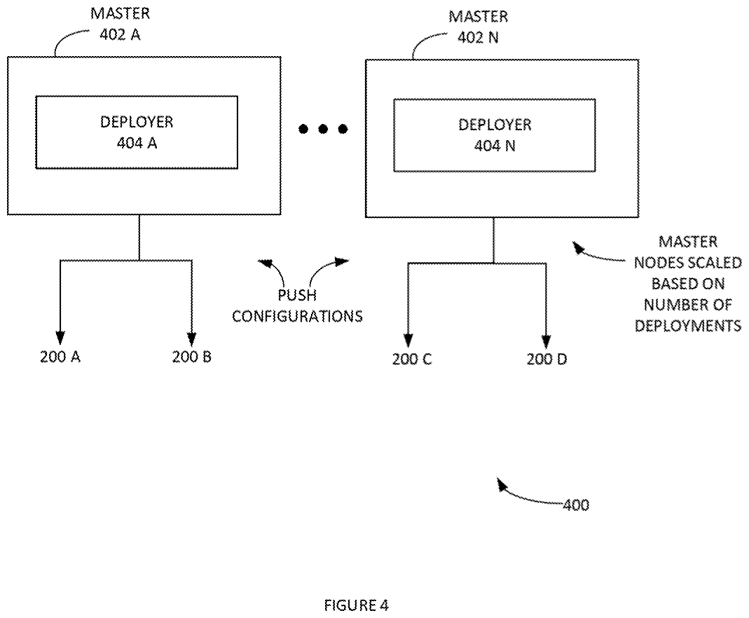

FIG. 4 illustrates an example system of large-scale replicated deployment, according to some embodiments. Master nodes 402 A-N can include deployers 404 A-N. Master nodes 402 A-N can be scaled based on the number of deployments of systems 200. Deployers 404 A-N can push configurations to systems 200 A-D (or any other number of iterations of systems 200.

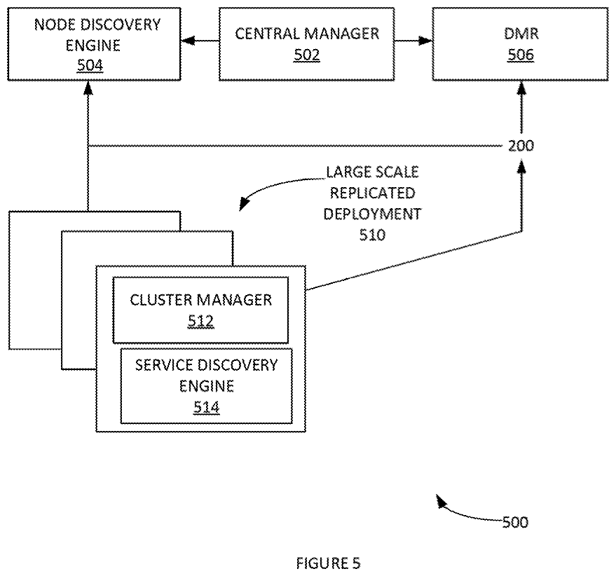

FIG. 5 illustrates an example Network Multi-Master Deployer (NMMD) system 500, according to some embodiments. NMMD system 500 can eliminate the above-mentioned problems by removing the requirement of a master deployer. In the system of FIG. 5, all nodes are masters and can identify their peers and automatically converge to become part of a multi-node deployment. Node Discovery Engine 504, Deployment Model Repository (DMR) 506, Central Manager 502 are a centralized service that is scale resilient. Cluster Manager 512 and Service Discovery Engine are available in each node on which the large-scale replicated deployment 510 is implemented.

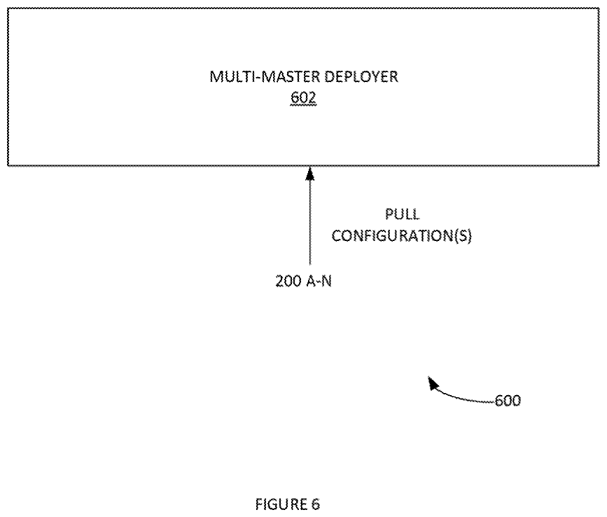

FIG. 6 provides an example component distribution 600, according to some embodiments. More specifically, FIG. 6 illustrates utilizing NMMD for large scale deployments, without scaling the NMMD by itself, according to some embodiments. The NMMD can enable orchestration of large scale replicated deployments without a requirement of a centralized master node to push configuration to these nodes. Multi-master deployer 602 can pull configurations from systems 200. Multi-master deployer 602 can be an NMMD system (e.g. a NMMD system 500).

An example method to provide instant application sandboxes without blocking resources in a cloud environment is now discussed. It is noted that Cloud Environments are generally used for two types of use-cases. In a first use case, Cloud Environments be used to run production workloads. In a second use case, Cloud Environments can be used to run virtual machines (VMs) for development and test environments (e.g. sandboxes). One issue faced by organizations when providing cloud infrastructure for such sandboxes is the associated processing costs as developers may have sandboxes continuously running. This can be due to the time costs of resetting a sandbox at a later time. As applications become more complex, the processing costs have also increase. Accordingly, as developers and testers keep the VMs continuously running, they increase the IT spending for the organization.

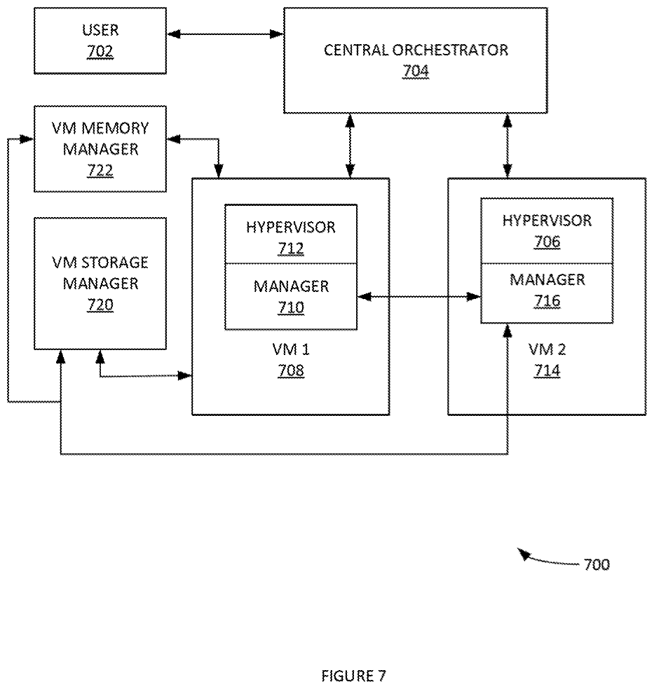

FIG. 7 illustrates an example system 700 for saving virtual machines in a sandbox environment, according to some embodiments. A central orchestrator 704 can communicate with a plurality of VM's (e.g. VM 1 708 and VM 2 714). As shown, the system of FIG. 7 includes, inter alia: hypervisors 706 712, hypervisor managers 710 716, a VM memory storage repository 720, a VM storage repository 722, and a central orchestrator 704. The functionalities of these components are provided in processes 800 and 900 infra.

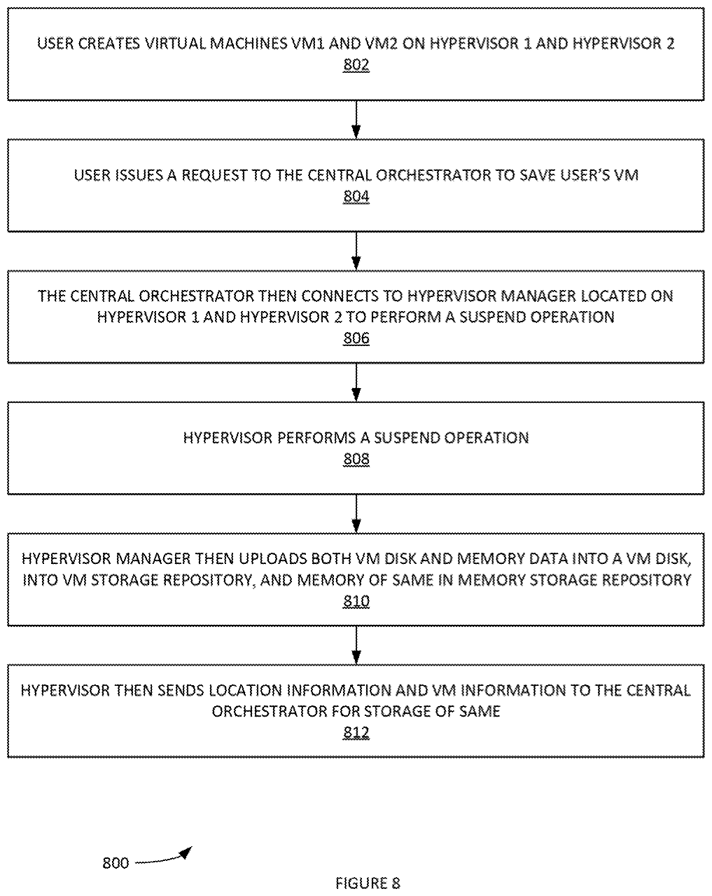

FIG. 8 illustrates an example process 800 for saving a virtual machine, according to some embodiments. In step 802, a user Creates Virtual Machines VM1 and VM2 on Hypervisor 1 and Hypervisor 2. The User may wish to move to a new environment and/or to save his work in order to later resume testing and development. In step 804, the user issues a request to the Central Orchestrator to save the user's VM. In step 806, the Central Orchestrator then connects to the Hypervisor Manager located on Hypervisor 1 and Hypervisor 2 to perform a suspend operation. In step 808, the Hypervisor performs a suspend operation. The suspend operation can dump the memory of the VM into a disk of the Hypervisor. The VM then shuts down. In step 810, the Hypervisor manager then uploads both the VM disk and the memory data into a VM disk, into the VM storage repository, and the memory of the same in the Memory Storage repository. The Virtual machine storage repository can have two folders. The first folder holds the VM storage (e.g. a hard disk) information and second folder can hold the VM memory storage information. Accordingly, the Virtual machine storage repository includes both the VM storage (e.g. hard disk) information and the VM memory storage information.

Every virtual machine has information associated in its hard disk and also the running configuration in RAM The Hypervisor manager then removes the entry of the Virtual machine from the Hypervisor. In step 812, the Hypervisor manager then sends the location Information and the VM information to the Central Orchestrator for storage of the same. The Hypervisor is now free to use the resources for other purposes.

Running Configuration refers to the configuration of the VM. Every VM can have a set of configurations that will decide the state of the device when it is brought up. This running configuration will be stored in the RAM (Random Access Memory). Since the RAM of VM are saved, once it is brought up, configuration from RAM can be rendered to bring the device back to same state.

Location refers to the Virtual machine storage repository that includes both VM storage (e.g. hard disk) and VM memory details. VM information refers to the metadata that includes the number of NICs, NIC bridge details, NIC type, Number of CPUs, CPU placement, CPU feature policy, Memory, OS (operating system) machine type. These can be used by the hypervisor eventually in bringing up the VM.

In some examples, it is noted that Hypervisor manager acts as an interface between central orchestrator and hypervisor. Hypervisor manager consists of: a) RESTful (REpresentational State Transfer) networking service; and b) Configuration management tool. The Central orchestrator communicates with the RESTful API exposed by networking service to pass the VM information, changes to the lifecycle state of VM like to suspend VM or terminate VM from ready state. These details received from orchestrator are written to the database managed by the networking service. Networking service can periodically look for any changes written to it by the central orchestrator. If any lifecycle state changes to the VM are observed, it can trigger the Configuration Management tool to work with the hypervisor to perform the necessary changes.

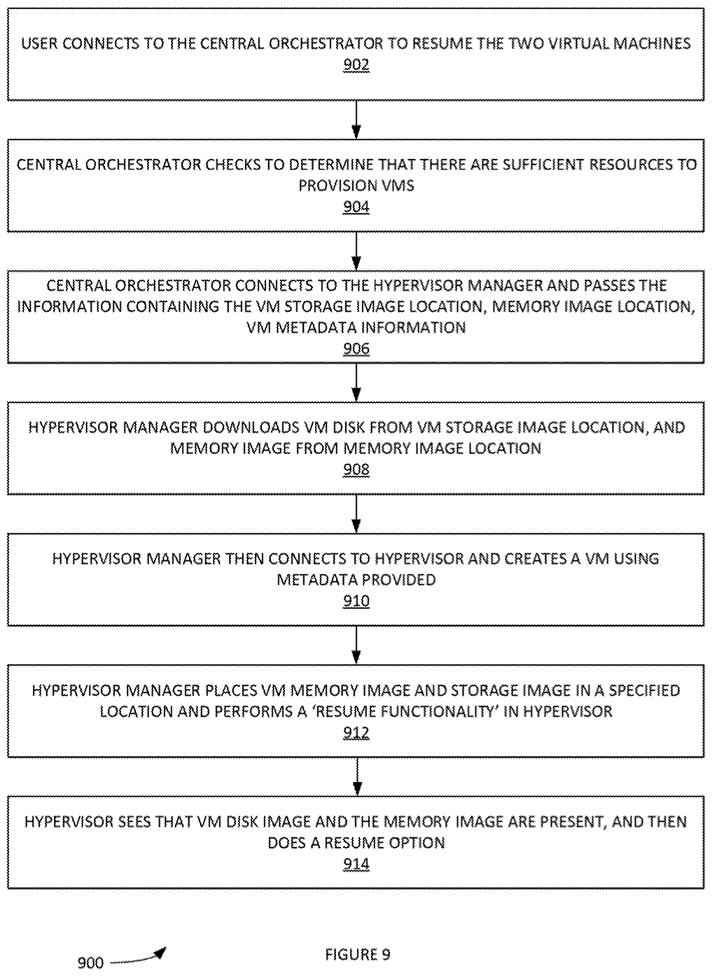

FIG. 9 illustrates an example process 900 for resuming a VM, according to some embodiments. A user may wish to resume his work session that includes two VMs in saved state. In step 902, the user connects to the Central Orchestrator to resume the two virtual machines. In step 904, the Central Orchestrator first checks to determine that there are sufficient resources to provision the VMs. In step 906, once the sufficient resources are verified, the Central Orchestrator connects to the Hypervisor Manager and passes the information containing the VM storage image location, memory image location, VM metadata information, etc. It is noted that VM storage location, memory location and metadata information that are being passed from central orchestrator to the hypervisor manager will be forwarded to the hypervisor for bringing up the VMs. VM metadata information can include the number of NICs (Network Interface Cards), NIC bridge details, NIC type, number of CPUs (Central Processing Units), CPU placement, CPU feature policy, Memory, OS (Operating System) machine type, etc. These can be used by the hypervisor eventually in bringing up the VM.

Additionally, the passing of information between the components are at two different points of the life cycle management of VMs and across two different hypervisors that are available on different servers. For example, when a VM is being suspended, hypervisor1 available on server) knows the latest information about the VMs, it will share this information to the hypervisor-manager1 on server 1 who sends this information with central orchestrator to store the details for future purpose. It is noted that server) may not be available in future due to many reasons like server capacity being full, powered off or other maintenance cases. When a VM has to be resumed or brought alive again, in case server) is not available, another available server2 can then be searched for this task. The central orchestrator already knows the VM information that it learnt from hypervisor-manager1 on server) earlier. The central orchestrator can now send this information (e.g. VM storage and memory) to the hypervisor-manager2 on server2. This information can be forwarded by hypervisor-manager2 to hypervisor2 on server2 and VM can be instantiated on server2. The Hypervisor-manager interacts with central orchestrator.

In step 908, the Hypervisor Manager downloads the VM disk from the VM storage Image location, and Memory Image from the Memory Image location. In step 910, the Hypervisor Manager then connects to the Hypervisor and creates a VM using the Metadata provided. In step 912, the Hypervisor Manager places the VM memory image and storage image in a specified location and performs a ‘resume functionality’ in the Hypervisor. In step 914, the Hypervisor sees that the VM disk image and the Memory Image are present, and then does a resume option. The resume option includes loading the Memory Image into the RAM RAM (Random Access Memory) and then launching the VM. The VM the starts from the same time it had been suspended with all the services in running state. The user does not need to do any configuration on the VMs and can resume his work. Memory image refers to the memory dump or RAM of the VM. When VM is suspended, this memory dump or the RAM can be stored as a file that can uploaded to an external system. Similarly, the storage image or hard disk of VM can be uploaded as file to external system. Memory image refers to the RAM of the VM and storage image refers to the hard disk of the VM.

Memory image or storage location can refer to this file location on external system. VM storage repository can have two (2) folders. One can be a folder for memory and one can be for storage or hard disk.

Additional Systems and Architecture

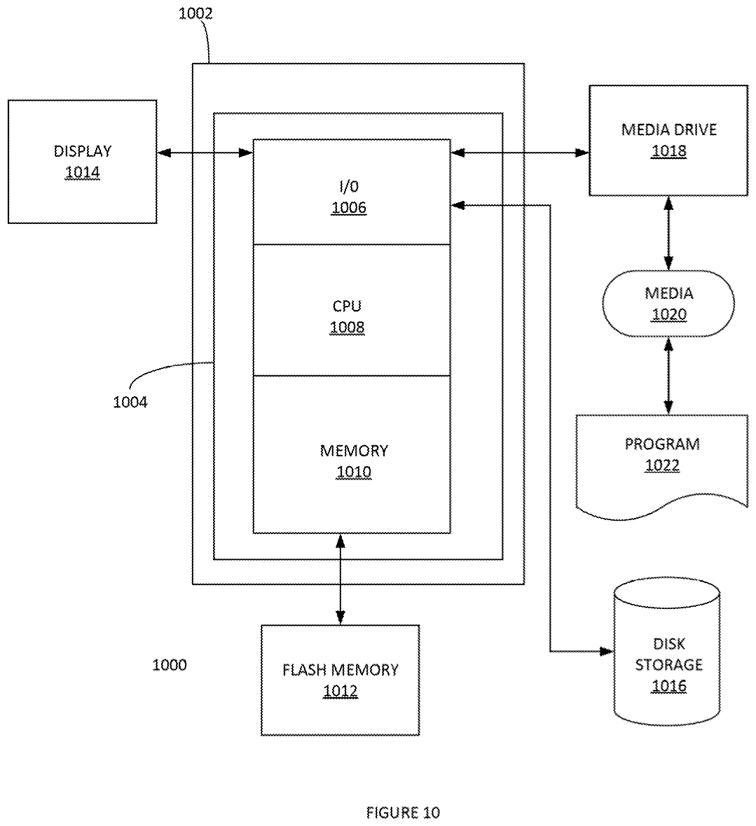

FIG. 10 depicts an exemplary computing system 1000 that can be configured to perform any one of the processes provided herein. In this context, computing system 1700 may include, for example, a processor, memory, storage, and I/O devices (e.g., monitor, keyboard, disk drive, Internet connection, etc.). However, computing system 1000 may include circuitry or other specialized hardware for carrying out some or all aspects of the processes. In some operational settings, computing system 1000 may be configured as a system that includes one or more units, each of which is configured to carry out some aspects of the processes either in software, hardware, or some combination thereof.

FIG. 10 depicts computing system 1000 with a number of components that may be used to perform any of the processes described herein. The main system 1002 includes a motherboard 1004 having an I/O section 1006, one or more central processing units (CPU) 1008, and a memory section 1010, which may have a flash memory card 1012 related to it. The I/O section 1006 can be connected to a display 1014, a keyboard and/or other user input (not shown), a disk storage unit 1016, and a media drive unit 1018. The media drive unit 1018 can read/write a computer-readable medium 1020, which can contain programs 1022 and/or data. Computing system 1000 can include a web browser. Moreover, it is noted that computing system 1000 can be configured to include additional systems in order to fulfill various functionalities. Computing system 1000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method useful for saving a virtual machine comprising:
creating a virtual machine on a hypervisor;
issuing a request to a central orchestrator to save the virtual machine, wherein the central orchestrator is accessed via a monitor interface, and wherein the central orchestrator communicates with a plurality of virtual machines that includes the virtual machine;
with the central orchestrator, connecting to a hypervisor manager located on the hypervisor where the virtual machine is located on the hypervisor and passes a set of information comprising a VM storage image location, and a VM memory image location, and wherein a VM memory image comprises a memory dump or Random Access Memory (RAM) of the VM;
with the hypervisor, performing a suspend operation on the virtual machine, wherein the suspend operation dumps a memory of the virtual machine into a disk of the hypervisor;
shutting down the virtual machine;
with the hypervisor manager, uploading both the virtual machine disk and the memory data into a virtual machine storage repository, and the memory data into a memory storage repository,
with the hypervisor manager, removing an entry of the virtual machine from the hypervisor;
with the hypervisor manager, sending a location information and the virtual machine's information to the central orchestrator for storage of the virtual machine's information;
resuming the virtual machine in a saved state with the central orchestrator, wherein the set of steps comprises:
with the central orchestrator:
determining that there are sufficient resources to provision the virtual machine in a specified computing system, and
connecting the central orchestrator to the hypervisor manager and passing the information containing the virtual machine's storage image location, the memory image location, and the virtual machine metadata information;
with the hypervisor manager:
downloading the virtual machine's disk from the virtual machine's storage image location, and the virtual machine memory image from the memory image location,
connecting to the hypervisor and creating a virtual machine using the virtual machine's metadata, and
placing the virtual machine's memory image and the virtual machine's storage image in a specified location; and
with the hypervisor:
determining that the virtual machine's disk image and the virtual machine's memory image are present, and
performing the resume functionality in the hypervisor.

2. The computerized method of claim 7, wherein the virtual machine has information associated in the virtual machine's hard disk and also a running configuration of the VM in the RAM.

3. The computerized method of claim 8, wherein the central orchestrator is implemented in a SAAS (Software as a Service) based Platform that provides a DevOPS enabled framework to implement an end to end orchestration of a complex multi-vendor network solution on cloud-computing infrastructure.

4. The computerized method of claim 9, wherein a resume option comprises loading the virtual machine's memory image into the RAM and then launching the virtual machine.

5. The computerized method of claim 11 further comprising:
starting the virtual machine from a same time that the virtual machine had been suspended with all the services in a running state such that a user does not need to do any configuration on the virtual machine and resume his work.
